(19) United States
(12) Patent Application Publication
(10) Pub. No.: US 2008/0043578 A1
(43) Pub. Date: Feb. 21, 2008

(54) Integrated magneto-Optical Write/Read Head

(75) Inventors: Frank Cornelis Penning, Turnhout (BE); Ferry Zijp, Eindhoven (NL); Aukje Arianne Annette Kastelijn, Eindhoven (NL); Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,876

(22) PCT Filed: Mar. 8, 2005
(86) PCT No.: PCT/IB05/50849

§ 371 Date: Jun. 28, 2007

(30) Foreign Application Priority Data
Mar. 19, 2004 (EP) 04101153.7

(51) Int. Cl. G11B 7/22

(52) U.S. Cl. 369/13.02

(57) ABSTRACT

A Method of Manufacturing an Integrated Magneto-Optical Element for use in a Digital Magneto-Optical Signal write/Read Head and an Integrated Magneto-Optical Element Manufactured According to the Method A method of manufacturing an integrated magneto-optical element for use in a digital magneto-optical signal read/write head, in which the manufacturing techniques of thin film coils are combined with lens-making techniques to realise a high performance, reliable and cost-effective lens-MFM coil combination for use in a slider having an air bearing surface for “flying” just above a surface of a storage medium (102) during operation. The method comprises two principal steps: Step I is to make an MFM coil (106) by means of a thin film technique, and Step 2 is to make an objective lens (114) on top of the transparent (e.g. glass) plate (109) in which the MFM coil (106) is located.

This invention relates generally to the field of Digital Magneto-Optical information storage and, more particularly, to the manufacture of an element for use in a digital magneto-optical signal write/read head, and an element manufactured by such a method.

Optical information recording has been developed as a high density recording method. One way to realise high-density recording is to apply magneto-optical (MO) recording. In such a recording process, data is written in a magnetic recording layer of a magnetic medium, e.g. a disc, by using a magnetic field for polarising magnetic particles in the recording layer. Information can be read from such a layer by optically detecting the Kerr rotation of polarised light, which is reflected from the relevant layer.

For most magnetic media, a relatively strong magnetic field is required to achieve a complete polarisation of the magnetic material due to the high coercivity of the medium. Heating up a magnetic medium drastically reduces the threshold value of the magnetic field intensity that is necessary for a complete polarisation.

Thermally assisted magnetic recording makes use of this phenomenon. In, for example, MO writing strategies with Laser Pulsed Magnetic Field Modulation (LP-MFM), a laser pulse is used to locally heat a magnetic medium, while a magnetic field, which is synchronised with the timing of the laser pulse, polarises the heated area. A magnetic head suitable for LP-MFM magneto-optical recording should have a magnetic-field-modulation (MFM) coil and usually has a transparent guide for guiding a laser beam. The laser beam can be used both for heating a magnetic medium and for reading data from the magnetic medium via the detection of the Kerr effect. Usually, the transparent guide is arranged to be coaxial with the coil and, in order to achieve sufficiently high magnetic field intensities with limited power consumption, the inner radius of the coil is as small as possible.

The size of the data bits which can be written by thermally assisted magnetic recording on a MO medium is limited by the size of the spot of the focused laser beam and the thermal profile of the spot, and the thermal profile of the medium itself. The optical size of the spot depends on the wavelength (8) of the laser light used and the numerical aperture (NA) of the optical path, yielding a diffraction limited spot with a radius (r) of the order of 0.61 λ/NA. In near field recording, a NA≧1 is possible by using the evanescent waves, which occur at a surface of total internal reflection of a refractive optical component. A requirement is that the magnetic head, particularly the optical component thereof, is positioned with respect to the recording medium at a distance which is only a fraction of the wavelength of the laser light used. In order to realise higher recording densities in MO recording, such as near field recording, it is desirable to reduce the head-to-medium distance towards the submicron range.

In a known system for magnetic recording into a storage medium, optical components are combined with a slider, the slider being carried by a suspension and being positioned below an objective lens of an actuator, an MFM coil being integrated in the slider. The slider is provided with an Air Bearing Surface (ABS) for “flying” just (say ˜1 :m) above a surface of the storage medium during operation.

For next generation high density magneto optical applications, for example some domain expansion technology, high NA optics and the presence of a fast magnetic field modulation (MFM) coil are necessary, see H. Awano, S. Ohnuki, H. Shirai, N. Ohta “Magnetic Domain Expansion Readout for an Ultra High Density MO Recording”, IEEE Transactions on Magnetics 5 (1997) p33, and various such systems have been demonstrated, based on both actuator and slider designs.

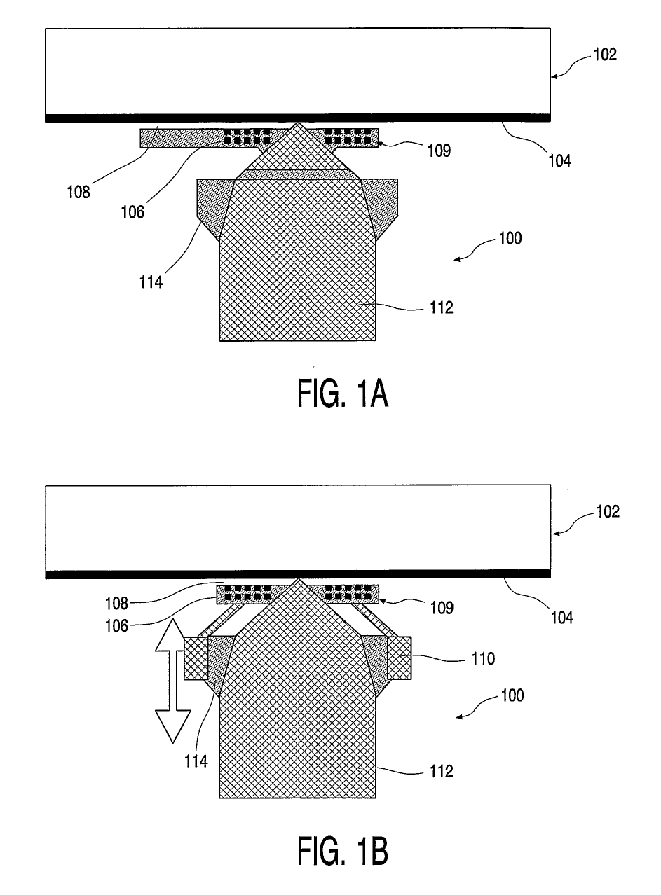

Referring to FIGS. 1A and 1B of the drawings, two different basic air incident recording techniques are illustrated schematically. In the arrangement of FIG. 1A, a slider 100 is illustrated flying at ˜1Φm above a disc 102 onto which a 14Φm acrylic cover 104 has been deposited on top of the recording stack. An MFM coil 106 is integrated into the air-bearing surface 108 of a glass plate 109 forming part of the slider 100 and is hence placed at approximately 15Φm from the recording layer 102. Laser light 112 is first incident on an objective lens 114 before passing through the plate 109 to the disc 102.

The arrangement illustrated in FIG. 1B of the drawings, is similar in many respects to that of FIG. 1A, and like components thereof are denoted by the same reference numerals. However, in this case, an actuator 110 is provided for controlling the 15Φm separation between the MFM coil 106 located in the glass plate 109 and the air incident recording stack 102.

It is an object of the present invention to provide a method of manufacturing a reliable and cost-effective integrated or unitary component comprising a thin film coil and objective lens combination by combining thin film coil manufacturing techniques and objective lens making techniques. A magneto-optical element is also provided, as is a method of manufacturing a magneto-optical write and/or read head, and a magneto-optical write and/or read head manufactured by the method.

In accordance with the present invention, there is provided a method of manufacturing an integrated magneto-optical element for use in a magneto-optical write and/or read head, comprising forming a thin-film in-plane magnetic coil in or on a transparent substrate, and then forming on said substrate an objective lens.

The present invention also extends to an integrated magneto-optical element comprising a thin-film in-plane magnetic coil in or on a transparent substrate and an objective lens, the element being manufactured according to the above-defined method.

The invention extends still further to a method of manufacturing a magneto-optical write and/or read head, the method including the step of manufacturing an integrated magneto-optical element as defined above, and to a magneto-optical read and/or write head manufactured according to this method.

The objective lens beneficially has a relatively very high numerical aperture (NA), typically greater than 0.85, and even more preferably greater than 0.9. The thin-film in-plane magnetic coil is preferably formed by deposition or galavanic growth of a layer of conductive material, such as copper, onto the transparent substrate. In one preferred embodiment, the magnetic coil comprises at least two layers of conductive material, separated by an insulating material. Alternatively, two or more layers of conductive material may be provided on a silicon substrate, which is subsequently adhered to a transparent substrate, in a Silicon on Anything (SoA) technique.

The objective lens may be made by a glass-photopolymer replication technique, glass moulding or plastic injection moulding, among other techniques. In one embodiment, an array of objective lenses is formed or mounted on a substrate having a plurality of respective magnetic coils provided thereon, and the substrate is then cut into a plurality of lens-coil combinations. Alternatively, a single lens is mounted or formed on a substrate having a single magnetic coil.

In a magneto-optical write and/or read head according to the invention, another lens may be provided above the lens-coil combination.

These and other aspects of the present invention will be apparent from, and elucidated with reference to, the embodiments described herein.

Embodiments of the present invention will now be described by way of examples only and with reference to the accompanying drawings, in which:

FIG. 1A is a schematic diagram illustrating a first slider design for use in a magneto-optical write/read head according to the prior art;

FIG. 1B is a schematic diagram illustrating a second slider design for use in a magneto-optical write/read head according to the prior art;

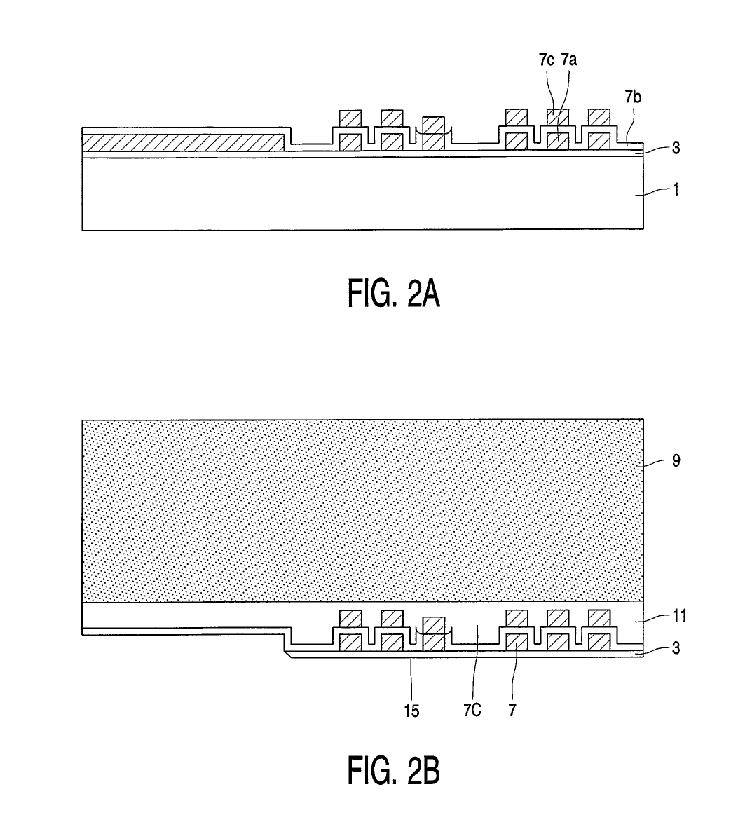

FIG. 2A is a schematic diagram illustrating an intermediate step in a Silicon on Anything (SOA) technique for forming a thin-film coil in a transparent substrate;

FIG. 2B is a schematic diagram of a final step in the SOA technique of FIG. 2A;

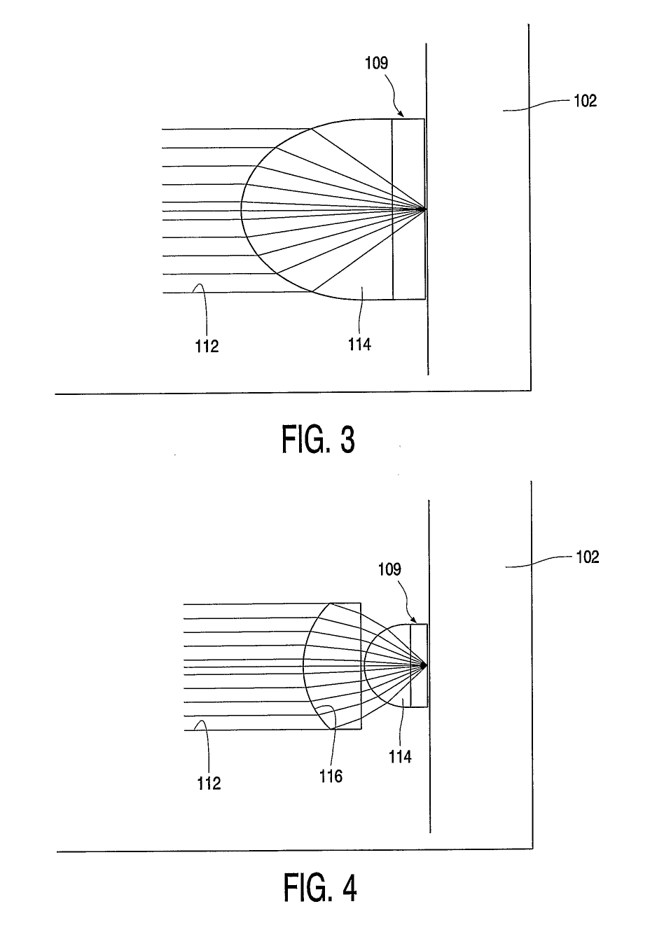

FIG. 3 illustrates schematically a magneto-optical element according to a first exemplary embodiment of the invention; and

FIG. 4 illustrates schematically a magnetic-optical element according to an exemplary embodiment of the invention.

By way of background information, a practical high NA objective lens may consist of a single lens or the combination of two different lenses to enlarge the manufacturing tolerances of such a lens. Different lens manufacturing techniques can be applied to making small lenses such as, for example, glass-2P technology (see J. Braat, A. Smid, M. Wijnakker, Appl. Opt. 24 (1985)p1853-1855), glass moulding technology (see S. Hirota, “Progress of Aspheric Glass Lenses”, International Workshop on Optics Design and Fabrication ODF'98 (Tokyo, 1998)p29-32), plastic injection moulding (see G. Poetsch, W. Michaeli, “Injection Moulding” (C. Hanser, 1995)), and even direct diamond turning of a lens from bare plastic.

Furthermore, in view of the fact that a fast MFM coil is necessarily small, such a coil can be made using known thin film technology. Practical thin film magnetic coil designs are known, and are described in more detail in International Patent Application No. WO01/82299. In addition, various techniques for this are known, such as standard galvanic growing to a glass substrate, or using the Silicon on Anything (SoA) technique for making such small coils, as described in International Patent Application No. WO02/13188.

As stated above, it is an object of the present invention to combine the manufacturing techniques of thin film coils with the lens-making techniques such that a high performance, reliable and cost-effective lens-MFM coil combination can be realised.

The method of the following exemplary embodiment of the present invention comprises two principal steps: Step 1 is to make an MFM coil by means of a thin film technique, and Step 2 is to make the objective lens on top of the transparent (e.g. glass) plate in which the MFM coil is located.

### Step 1

In one exemplary embodiment of the present invention, it may be desired to employ a multi-layer MFM coil, such as that described in WO01/82299, then standard thin film technology may be used. Thus, starting with a transparent material, such as glass (BK7) or crystalline material such as quartz, two or more coil layers are deposited or galvanically grown onto the transparent substrate, the two or more coil layers extending substantially parallel to one another. The coils are separated from one another by respective layers of isolating material, such as SiO2 or AlO2, which can be deposited using sputtering techniques. After planarisation steps, the result of this manufacturing technique is typically a flat wafer of transparent material, in which a series of MFM coils is embedded.

In another exemplary embodiment of the present invention, an alternative manufacturing technology may be employed, such as that described in WO02/13188, which discloses the Silicon on Anything (SoA) technique. The method starts with a silicon substrate 1 on which an oxide, such as SiO₂ or Al₂O₃, is deposited by, for example, thermal oxidation, sputtering or vapour deposition, to form a thin top layer 3. Next, a first conductive or metallic layer 7a having one or more coil turn sections is formed on one side of the substrate 1 by, for example, sputter deposition or electro deposition of copper or other suitably conductive material. Then a non-conductive layer 7b is formed on the first conductive layer 7a by, for example, deposition of SiO₂ or Al₂O₃, or by spin-coating of a polymer. Thereafter, a second conductive layer 7c is formed on the insulating layer 7b and an interconnection is made, for example, by locally etching the non-conducting layer 7b before the second conductive layer 7c is formed. Thus, with this technique, a wafer with a series of embedded coils results: with the exception that the basic substrate is now standard silicon, rather than being a transparent (e.g. glass) plate, as shown in FIG. 2A of the drawings. In this case, therefore, the substrate 1 may be adhered, and particularly glued (via layer 11), to a second, transparent (e.g. glass) substrate 9. A suitable glue is, for example, acrylate resin varnish or 1,6-hexanediodiacrylate. The silicon substrate 1 and one or more laid open portions of the conductive layer are then etched away using, for example, hot KOH etching, to create an air bearing surface 15, as shown in FIG. 2B of the drawings. Alternatively, however, the silicon wafer may be left in place during Step 2 of the manufacturing process.

### Step 2

Irrespective of the method of manufacturing an MFM coil embedded in a transparent plate, an objective lens can be made on top of the transparent plate by means of a number of different methods.

For example, a glass-photopolymer (glass-2P) process may be used to replicate an aspherical lens directly on top of the glass plate containing the coil. Replication is a technology in which a thin layer of lacquer is shaped on a substrate, for example, a glass plate, with the aid of a mold. In a preferred method, a UV-curing lacquer is used which, after UV curing, forms a stable polymer with good chemical and mechanical resistance. The mold may be treated with a release layer which allows replication of a large number of lenses without any re-treatment. The mold may be made of a UV-transparent material (e.g. fused silica) so that the lacquer can be irradiated through the mold.

Briefly, the method steps comprise filling the mold with lacquer and positioning the glass plate above the mold. The glass plate is placed against the mold and properly aligned. When the plate is well-aligned, the lacquer is hardened by illumination with UV light. Thus, it is possible to replicate an array of aspherical lenses on the plate and then cut the plate into separate lens/coil units. This is a very cost-effective process. Referring to FIG. 3 of the drawings, it is illustrated that it is possible to make a very high quality lens for use in an exemplary embodiment of the invention using the glass/2P moulding process. Using the same reference numerals as those used in respect of FIGS. 1A and 1B for like components, the lens 112 provided on the substrate 109 has a NA of 0.85, an entrance pupil of 1.0 mm and a wavelength of 405 nm. The free working distance is 10 microns.

In another method, an array of injection molded lenses may be made and mounted on top of the glass plate. The wafer is then cut into separate lens/coil units.

In yet another method, separate objective lenses may be made by the glass/2P, glass moulding or plastic injection moulding process, and these separate lenses may then be mounted on respective separate glass plates (having MFM coil embedded therein). This requires a separate mounting step in the manufacturing process for each lens-MFM coil combination, but it eases the manufacturing tolerances of the lenses.

In yet another exemplary method, and referring to FIG. 4 of the drawings, a lens 114, which may comprise a glass sphere (made by a glass moulding process), a plastic lens (made by a plastic injection moulding process), or a lens made by the glass/2P method described in detail above, is provided on top of the glass plate in which an MFM coil is embedded, as before. Then, an additional lens 116 is mounted above this glass plate/coil/lens unit. This requires an additional step but allows for a very high-NA objective lens with coil, typically NA>0.85 or even NA>0.9. In one specific example, the lens has an NA=0.95, an entrance pupil of 1.5 mm and a wavelength of 405 nm. The free working distance is 10 microns.

Thus, the present invention provides a method of manufacturing a high-performance, reliable and cost-effective lens-MFM coil combination, which is suitable for use in all magneto-optical (MO) recording systems

Embodiments of the present invention have been described above by way of examples only, and it will be apparent to a person skilled in the art that modifications and variations can be made to the described embodiments without departing from the scope of the invention as defined by the appended claims. Further, in the claims, any reference signs placed between parentheses shall not be construed as limiting the claim. The term “comprising” does not exclude the presence of elements or steps other than those listed in a claim. The terms “a” or “an” does not exclude a plurality. The invention can be implemented by means of hardware comprising several distinct elements, and by means of a suitably programmed computer. In a device claim enumerating several means, several of these means can be embodied by one and the same item of hardware. The mere fact that measures are recited in mutually different independent claims does not indicate that a combination of these measures cannot be used to advantage.

1. A method of manufacturing an integrated magneto-optical element for use in a magneto-optical write and/or read head, comprising forming a thin-film in-plane magnetic coil (106) in or on a transparent substrate (109), and then forming on said substrate (109) an objective lens (114).

2. A method according to claim 1, wherein said objective lens (114) has a relatively very high numerical aperture (NA).

3. A method according to claim 2, wherein said objective lens (114) has a NA>0.85.

4. A method according to claim 3, wherein said objective lens (114) has a NA>0.9.

5. A method according to claim 1, wherein the thin-film in-plane magnetic oil (106) is formed by deposition or galvanic growth of a layer of conductive material onto the substrate (109).

6. A method according to claim 1, wherein two or more layers of conductive material are provided on a semiconductor substrate, which is subsequently adhered to a transparent substrate (109).

7. A method according to claim 1, wherein the magnetic coil (106) comprises at least two layers of conductive material separated by an insulating material.

8. A method according to claim 1, wherein the objective lens (114) is made by one of glass-photopolymer replication technique, glass moulding or plastic injection moulding.

9. A method according to claim 1 wherein an array of objective lenses (114) is formed or mounted on a substrate (109) having a plurality of respective magnetic coils (106) provided thereon, and the substrate (109) is then cut into a plurality of lens-coil combinations.

10. A method according to claim 1, wherein a single lens (114) is mounted or formed on a substrate (109) having a single magnetic coil (106).

11. An integrated magneto-optical element comprising a thin-film in-plane magnetic coil in or on a transparent substrate (109) and an objective lens (114), the element being manufactured according to claim 1.

12. A method of manufacturing a magneto-optical write and/or read head, the method including the step of manufacturing an integrated magneto-optical element according to the method of any one of claim 1.

13. A magneto-optical read and/or write head manufactured according to the method of claim 12.

14. A magneto-optical write and/or read head according to claim 13, wherein a further lens (116) is provided above the lens-coil combination.
